(19) United States
(12) Patent Application Publication
(10) Pub. No.: US 2022/0272975 A1
(43) Pub. Date: Sep. 1, 2022

(54) COMPOSITIONS AND METHODS FOR TREATING PLANT PARASITES

(71) Applicant: Arizona Board Regents on Bealf of the University of Arizona, Tucson, AZ (US)

(72) Inventors: Ayako Kusakabe, Tucson, AZ (US); S. Patricia Stock, Tucson, AZ (US); Istvan Molnar, Tucson, AZ (US)

(21) Appl. No.: 17/625,415

(22) PCT Filed: Jul. 9, 2020
(86) PCT No.: PCT/US2020/041315

§ 371 Date: Jan. 7, 2022

Related U.S. Application Data
(60) Provisional application No. 62/872,009, filed on Jul. 9, 2019.

(51) Int. Cl. A01N 43/38; A01N 37/06

(52) U.S. Cl. CPC A01N 43/38; A01N 37/06; A01P 5/00

(57) ABSTRACT

The present invention relates to compositions and methods for preventing and/or treating plant parasitic nematodes. OIn particular, the present invention provides metabolites produced by Photorhabdus bacteria and use of such metabolites to treat or prevent nematode disease in plants.

### CROSS-REFERENCE TO RELATED APPLICATIONS

This application claims the priority benefit of U.S. Provisional Application No. 62/872,009, filed Jul. 9, 2019, which is incorporated herein by reference in its entirety.

### FIELD OF THE INVENTION

The present invention relates to compositions and methods for preventing and/or treating plant parasitic nematodes. In particular, the present invention provides metabolites produced by Photorhabdus bacteria and use of such metabolites to treat or prevent nematode disease in plants.

### BACKGROUND

Root-knot nematodes are plant-parasitic nematodes in the genus Meloidogyne. Root-knot nematodes (Meloidogyne spp.) are one of the three most economically damaging genera of plant-parasitic cs on horticultural and field crops. Root-knot nematodes are distributed worldwide and are obligate parasites of the roots of thousands of plant species, including monocotyledonous and dicotyledonous, herbaceous and woody plants. They exist in soil in areas with hot climates or short winters. About 2000 plants worldwide are susceptible to infection by root-knot nematodes and they cause approximately 5% of global crop loss. (Sasser J N, Carter C C: Overview of the International Meloidogyne Project 1975-1984. In: An Advanced Treatise on Meloidogyne. Edited by Sasser J N, Carter C C. Raleigh, North Carolina State University Graphics; 1985:19-24.) Root-knot nematode juveniles infect plant roots, causing the development of root-knot galls that drain the plant's ability to take up nutrients and water. Infection of young plants may be lethal, while infection of mature plants causes decreased yield. The citrus nematode, T. semipenetrans, causes damage to citrus trees, leading to significant economic losses in multiple regions of the southwestern U.S. and other parts of the world. In Arizona, these plant-parasitic nematode species are the most important plant parasites.

The banning of several chemical nematicides has prompted the need for new and environmentally friendly methods to enhance current management of plant parasitic nematodes.

### SUMMARY OF THE INVENTION

Experiments described herein identified metabolites with specific activity against plant-parasitic nematodes. Insect pathogenic Photorhabdus bacteria, the natural symbionts of Heterorhabditis entomopathogenic nematodes were screened for biologically active secondary metabolites (SMs) with antibacterial, antifungal, insecticidal, and nematicidal activities. Three metabolites were isolated and purified from culture filtrates of P. I. sonorensis (strain Caborca) by bioassay-guided fractionation. The structures of pure, bioactive SMs were elucidated by nuclear magnetic resonance (NMR) spectroscopy. In vitro assays were carried out to assess the nematicidal activity of these Photorhabdus-derived SMs and determine the lethal concentration of these SMs (LC₅₀) against the root-knot nematode (Meloldogyne incognita) and also against the citrus nematode (Tylenchulus semipenetrans), which are among the most damaging plant parasites worldwide. A plurality of metabolites with specific activity against pathogenic, but not beneficial, non-target, beneficial soil nematodes were identified.

Accordingly, provided herein is a method of treating or preventing infection by a nematode, comprising: contacting the nematode with one or more metabolites (e.g., SMs of Photorhabdus bacteria such as, for example, Photorhabdus l. sonorensis), for example, trans-cinnamic acid (TCA), (4E)-5-phenylpent-4-enoic acid (PPA), or indole (ID) or their mixtures (e.g., TCA+PPA or TCA+PPA+ID). In some embodiments, the nematode is a plant pathogen (e.g., M. incognita or T. semipenetrans). In some embodiments, the metabolites have nematistatic and/or nematicidal activity. In some embodiments, the metabolite is applied at a concentration of 5 to 1000 μg/ml (e.g., 5 to 600, 5 to 500, 5 to 400, 5 to 300, 10 to 600, 10 to 500, 10 to 400, 10 to 300, 20 to 500, 20 to 400, 20 to 300, 40 to 500, or 40 to 400 μg/ml). In some embodiments, TCA is applied at a concentration of 10 to 500 μg/ml, PPA is applied at a concentration of 10 to 400 μg/ml, and ID is applied at a concentration of 10 to 400 μg/ml. In some embodiments, the metabolite does not kill or inhibit the growth of beneficial soil nematode species. In some embodiments, the metabolites are applied to a plant and/or soil. In some embodiments, the application is repeated on or more times at regular or irregular intervals.

Additional embodiments provide the use of one or more metabolites selected from, for example, trans-cinnamic acid, (4E)-5-phenylpent-4-enoic acid, or indole to treat or prevent plant infection by a nematode.

Further embodiments provide one or more metabolites selected from, for example, trans-cinnamic acid, (4E)-5-phenylpent-4-enoic acid, or indole for use to treat or prevent infection by a nematode.

Certain embodiments provide a composition, comprising one or more metabolites selected from, for example, trans-cinnamic acid, (4E)-5-phenylpent-4-enoic acid, or indole for use to treat or prevent infection by a nematode.

Yet other embodiments provide the use of a composition, comprising one or more metabolites selected from, for example, trans-cinnamic acid, (4E)-5-phenylpent-4-enoic acid, or indole to treat or prevent infection by a nematode.

In other embodiments, provided herein is a composition, comprising one or more metabolites selected from, for example, trans-cinnamic acid, (4E)-5-phenylpent-4-enoic acid, or indole formulated for application to a plant or soil. Additional embodiments are described herein.

### BRIEF DESCRIPTION OF THE DRAWINGS

FIG. 1 shows TCA activity on mortality of nematodes of different species.

FIG. 2 shows PPA activity on mortality of nematodes of different species.

FIG. 3 shows ID activity on mortality of nematodes of different species.

FIG. 4A shows the life cycle of entomopathogenic nematodes and Photorhabdus.

FIG. 4B shows in vivo production of secondary metabolites in Heterorhabditis sonorensis-infected larval cadavers of G. mellonella.

FIG. 4C shows the galled root systems of tomato plants infected by M. incognita for 2.5 months.

FIG. 4D shows the infective stage of M. incognita.

### DETAILED DESCRIPTION

As described above, experiments conducted during the course of development of embodiments of the present disclosure identified SMs that have nematicidal and nematistatic activity against plant-pathogenic nematodes. Such metabolites find use in the treatment and prevention of plant infection by pathogenic nematodes. The present disclosure is not limited to particular metabolites. In some embodiments, the metabolites are one or more of trans-cinnamic acid, (4E)-5-phenylpent-4-enoic acid, or indole (e.g., specific nematicidal and nematistatic activity against plant parasitic nematodes, but no or much reduced activity against non-pathogenic nematodes).

Metabolites are obtained using any suitable method. In some embodiments, metabolites (e.g., one or more of TCA, PPA, or ID) are chemically synthesized using any suitable method. In other embodiments, metabolites (e.g., one or more of TCA, PPA, or ID) are isolated from bacteria such as Photorhabdus bacteria such as, for example, Photorhabdus l. sonorensis. In some embodiments, commercially available sources of metabolites are utilized (e.g., Sigma-Aldrich, St. Louis, Mo.).

In some embodiments, a single metabolite is used in anti-nematode formulations. In some embodiments, a combination of two or more metabolites (e.g., TCA+PPA or TCA+PPA+ID) is used in anti-nematode formulations.

In some embodiments, the metabolite is applied at a concentration of 5 to 1000 μg/ml (e.g., 5 to 600, 5 to 500, 5 to 400, 5 to 300, 10 to 600, 10 to 500, 10 to 400, 10 to 300, 20 to 500, 20 to 400, 20 to 300, 40 to 500, or 40 to 400 μg/ml).

In some embodiments, the metabolite is formulated for application to a plant and/or soil. In some embodiments, composition comprise one or more of an adjuvant (e.g., a surfactant, a wetting agent, an emulsifier, a spreader, a foaming or anti-foaming agent, a buffer, a thickener, or a safener), a solvent (e.g., water based or petroleum based), a dust, a granule, or an additional active agent (e.g., insecticide, fungicide, pesticide, herbicide, or fertilizer). For example, See e.g., “Formulations”. Applying Pesticides Correctly—A Guide for Private and Commercial Applicators, revised 1991. The Ohio State University and Information Impact; Extension; herein incorporated by reference in its entirety. Service, USDA; and Office of Pesticide Programs, EPA. Pgs. 31-37.

In some embodiments, compositions are formulated as water miscible formulations for mixing with water then applying as sprays. Water miscible formulations include emulsifiable concentrates, wettable powders, liquid concentrate, soluble powder, suspension concentrate, capsule suspensions, water dispersible granules, granules, dusts, and microgranules. Specialist formulations are available for ultra-low volume spraying, fogging, fumigation, etc.

The present disclosure is not limited to a particular plant parasitic nematodes. In some embodiments, the nematode is a Meloidogyne sp. (e.g., including but not limited to, Meloidogyne acronea, Meloidogyne ardenensis Santos, 1968, Meloidogyne arenaria, Meloidogyne artiellia, Meloidogyne brevicauda, Meloidogyne chitwoodi, Meloidogyne coffeicola, Meloidogine exigua, Meloidogyne fruglia, Meloidogyne gajuscus, Meloidogyne hapla, Meloidogyne incognita, Meloidogyne javanica, Meloidogyne enterolobii (Meloidogyne mayaguensis), Meloidogyne naasi, Meloidogyne partityla, or Meloidogyne thamesi. In some embodiments, the nematode is Meloidogyne incognita. In some embodiments, the nematode is the citrus nematode Tylenchulus semipenetrans.

In some embodiments, the compositions described herein treat or prevent infection of plants (e.g., agricultural plants or corps) by pathogenic nematodes. In some embodiments, the compositions are applied to the plant or soil prior to or after signs of infection are observed.

In some embodiments, compositions are applied one or more (e.g., 1, 2, 3, 4, 5, or more times) at an interval of daily, weekly, monthly, or other interval. In some embodiments, crops are tested or examined for signs or infection by plant parasitic nematodes during treatment and the frequency or concentration of the SMs is altered based on the presence of plant parasitic nematodes.

### EXPERIMENTAL

### Example I

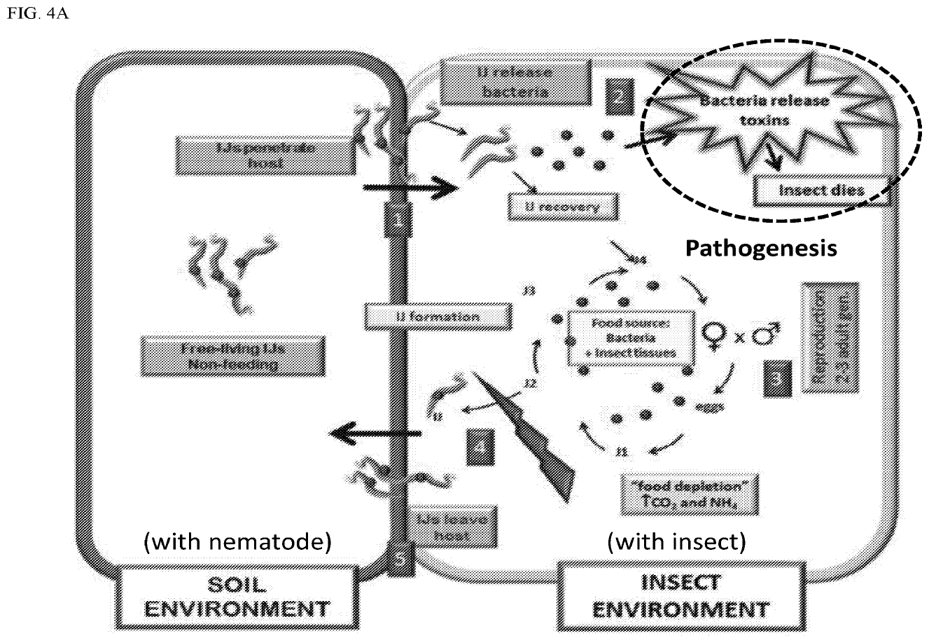

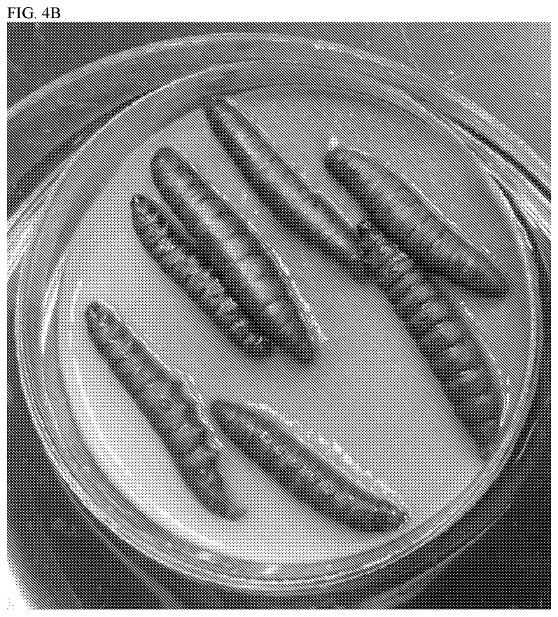

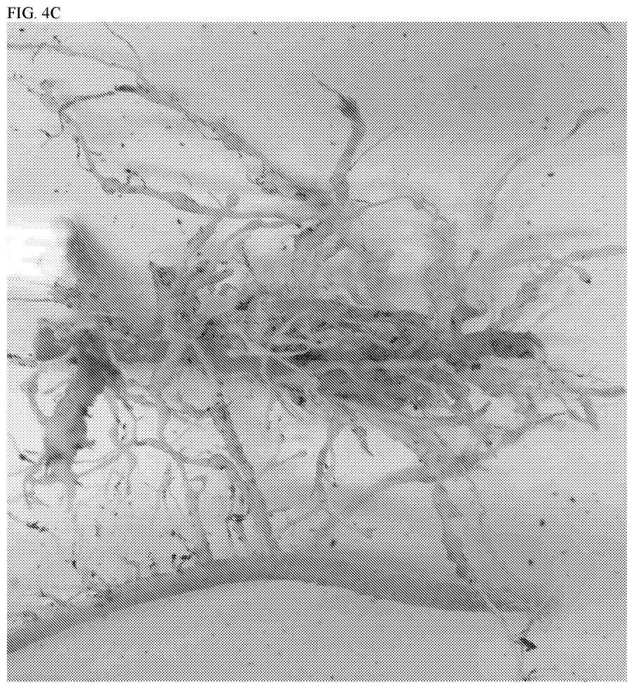

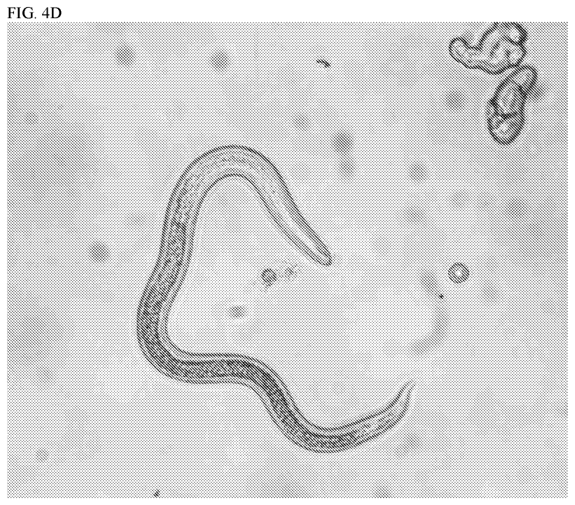

This example describes isolation and characterization of nematicidal and nematistatic activity of SMs produced by the entomopathogenic bacterium Photorhabdus l. sonorensis (Enterobacteriaceae) against the root knot nematode, M. incognita (Nematoda, Tylenchidae) as the primary indicator organism (FIG. 4A-D).

Isolation/Identification of the Nematicidal SMs: The cell-free broth (10 L) of culture filtrate of PLS was extracted with ethyl acetate and concentrated in a rotary evaporator. Chromatographic separation of ethyl acetate extracts of P. l. sonorensis was conducted using a silica gel column (22 mm×450 mm) with a stepwise gradient of chloroform: methanol, starting at CHCl₃: MeOH=100:0, then 99:1, 98:2, 97:3, 95:5, 93:7, 90:10, 80:20, and 0:100, yielding nineteen fractions per strain/extract. Each fraction was evaluated in a bioassay against M. incognita. Bioactive fractions, which were detected by nematicidal bioassay as described below, were further purified by preparative high-performance liquid chromatography (prep. HPLC) and three major compounds were isolated. The chemical structures and purities of the isolated compounds were determined by nuclear magnetic resonance (NMR) analysis (one dimensional H⁺ and C-NMR spectra), and liquid chromatography-mass spectrometry (LC-MS) to determine molecular weight and ion fragmentation patterns. All chemicals used in this and other experiments in this study were HPLC grade.

Three active molecules were isolated, purified, and identified:

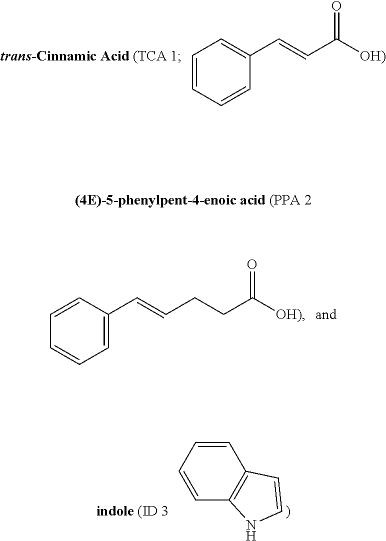

Laboratory assays were carried out to assess the nematicidal activity of the above-mentioned secondary metabolites (SMs) on the infective stage (i.e. the one that infects the roots of plants) of: 1) the root-knot nematode, (M. incognita); and 2) the citrus nematode (T semipenetrans). The effect of these SMs on five beneficial soil nematode species microbivores and those involved in nutrient cycling) was also tested to make sure these compounds only affect plant parasites (only for individual SM experiments).

Five non-target nematode species includes:

two free-living bacterivores: Caenorhabditis elegans and Rhabditis blumi.

three entomopathogenic species: Steinernema carpocapsae, H bacteriophora, and H sonorensis.

### Nematicidal Activity of Individual SMs

Results from these experiments showed these individual SMs have different inhibitory activity ranging from a transient immobility (nematistatic) to absolute death (nematicidal). The susceptibility of test population to these SMs was assessed by constructing a dosage-mortality curve in which the dosage was plotted against the percentage mortality at a given period of time (FIGS. 1-3). Based on Probit analysis, the data obtained from acute toxicity tests of TCA, PPA, and ID are as follows (Table 1).

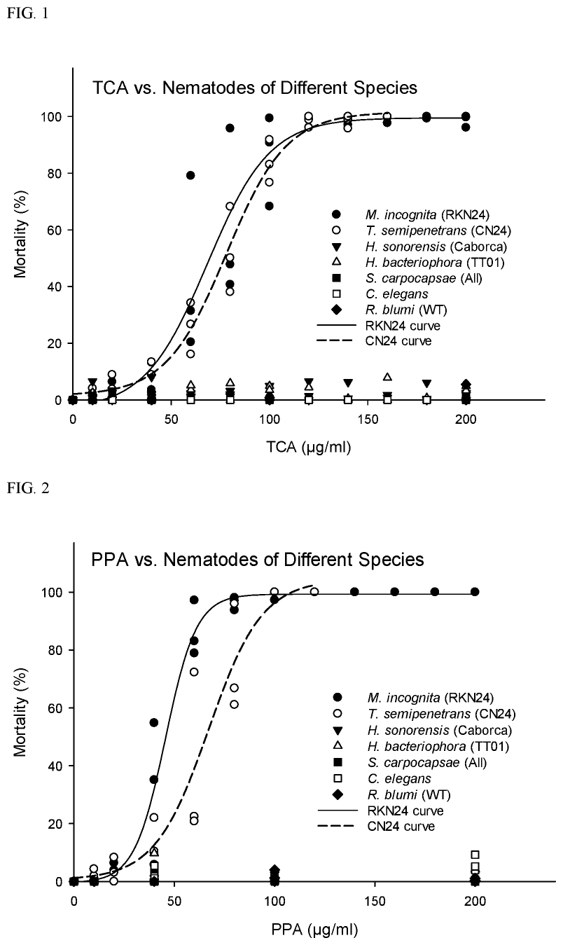

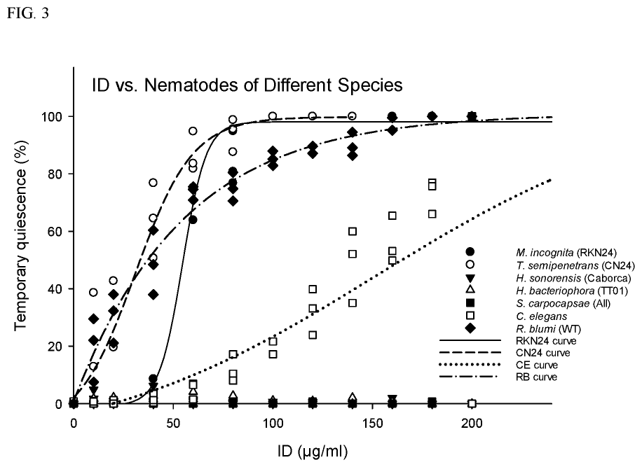

TCA showed nematicidal activity against M. incognita and T. semipenetrans (FIG. 1 and Table 1). At 24 h of exposure, the TCA concentration required to kill 50% nematode population (LC₅₀) was 67 μg/ml against M. incognita and 76 μg/ml against T. semipenetrans. PPA showed nematicidal activity against M. incognita and T. semipenetrans (FIG. 2_{[AK1]}) and Table 1). At 24 hr of exposure, LC₅₀ of PPA was 44 μg/ml against M. incognita and 66 μg/ml against T. semipenetrans. From the observational data sets, TCA and PPA had nematicidal activity against M. incognita and T. semipenetrans at concentrations equal or higher than 60 and 40 μg/ml, respectively.

ID exhibited nematistatic activity, inducing reversible quiescence against M. incognita and T. semipenetrans at concentrations of >40 μg/ml and >10 μg/ml, respectively (FIG. 3 and Table 1). The concentration required to immobilize 50% of nematode population (EC₅₀) was 56 μg/ml against M. incognita and 37 μg/ml against T. semipenetrans. ID showed nematicidal activity against M. incognita and T. semipenetrans at ≥300 μg/ml, respectively (Table 2 and 3). The LC₅₀ value of ID were 307 μg/ml against M. incognita and 388 μg/ml against T. semipenetrans.

These three SMs, however, had no effect on other beneficial soil nematode species at concentrations at 200 μg/ml or lower (Table 1).

### Time Course of Individual SM Exposure

Time points for observations were at 24, 48, and 72 h after initial exposure of each SM against J2 juveniles of M. incognita and T. semipenetrans under in vitro conditions. Taking the time course of exposure into account, lower concentrations of TCA were required to kill 50% M. incognita and T. semipenetrans (Table 2). At 48 or 72 hr of exposure, PPA also behaved similar to TCA, required lower concentrations to kill 50% nematodes population of M. incognita, and T. semipenetrans (Table 3). It was also observed that, at 48 and 72 hr, higher concentrations were needed to cause reversible paralysis (temporary quiescence) of the nematode populations of M. incognita and T. semipenetrans (Table 4).

### Nematicidal Activity of SM Mixtures

After assessments of individual SM toxicity, the combined toxic effects of these SMs was assayed in order to understand interaction between each SM. Results from these experiments showed these SM mixtures produced different effects ranging from antagonistic, additive, and synergistic toxicity. Interaction effects among Photorhabdus-derived SM mixtures on M. incognita and T. semipenetrans are presented in Table 5 and 6, respectively. In addition, the additive index values were calculated and indicated in each Table. Mixture toxicity against M. incognita: The LC₅₀ values of the mixture TCA+PPA, PPA+ID, and TCA+PPA+ID were 22.9, 40, and 19.9 μg/ml, which were lower than the single metabolite LC₅₀ of TCA alone, PPA alone, and ID alone, respectively (Table 5).

The TCA+PPA mixture and the TCA+PPA+ID mixture caused synergistic toxicity with calculated additive indices of 0.17 (the range computed from the 95% confidence interval=0.04 to 0.38) and 0.24 (range, 0.03 to 0.49), respectively. The PPA+ID mixture caused additive toxicity (−0.03 additive index, range −0.07 to 0.50). The combination of TCA+ID showed antagonistic toxicity with additive index of −0.31 (range, −0.34 to −0.27). Mixture toxicity against T. semipenetrans: The LC₅₀ values of the mixture TCA+PPA, PPA+ID, and TCA+PPA+ID were 40.6, 66.9, and 27.3 μg/ml, which were equivalent to or lower than the single metabolite LC₅₀ of TCA alone, PPA alone, and ID alone, respectively (Table 6).

The TCA+PPA+ID mixture only caused synergistic toxicity with an additive index of 0.19 (range, 0.01 to 1.17). The combinations of TCA+PPA and PPA+ID caused weakly antagonistic toxicity with additive indices of only −0.15 (range, −0.32 to −0.10) and −0.18 (range, −0.35 to −0.16), respectively. The combination of TCA+ID showed antagonistic toxicity with additive index of −0.45 (range, −0.51 to −0.05).

### Data Analysis

Concentration-response data for each concentration of single Photorhabdus-derived SMs and the mixtures were pooled and subjected to Probit regression analysis using the Polo Plus program (LeOra software, Petaluma, Calif.). The LC or EC values, along with corresponding 95% confidence intervals, were estimated for each single SM and SM mixture at each exposure time, depending on the experimental setting. Statistically significant differences in LC or EC values among SMs at a given exposure time period within or among nematode species were interpreted based on non-overlapping of 95% confidence intervals. For the toxicity data visualization, the relationship between percent mortality or temporary quiescence and concentration was described by a sigmoidal curve, which is fitted by the logistical function, using the statistical software package Sigmaplot for Windows, version 14.0 (Systat Software Inc., San Jose, Calif., USA). The inflection point of the sigmoidal curve corresponds to the concentration that kills or immobilizes 50% of the test population (irreversible lethal concentration, LC₅₀, or effective concentration, EC₅₀), which has been used for predicting lethal or effective concentration.

When analyzing the results of combination effects of the SMs, the statistical method described by DeLorenzo and Serrano (2003) was used as follows: S=(Am/Ai)+(Bm/Bi). Where: S=sum of biological activity or total toxicant unit (TTU); Am=LC₅₀ for compound A in the mixture; Ai=LC₅₀ for compound A in the individual effect; Bm=LC₅₀ for compound B in the mixture; Bi=LC₅₀ for compound B in the individual effect. S values will be used to calculate an additive index. If S≤1.0, then the additive index=(1/S)−1.0. If S≥1.0, then the additive index=S(−1)+1.0, An additive index less than zero indicates antagonistic toxicity. An additive index greater than zero indicates synergistic toxicity. An index with confidence limits overlapping zero indicates the mixture has additive toxicity.

TABLE 1
Nematicidal or nematistatic activity of TCA, PPA, and ID against
nematodes of different species under in vitro conditions.

| Com- | | | | |
|---|---|---|---|---|
| pound | Species | | 95% CI^{c} | Slope (± SE) |
| | | LC₅₀^{a} (μg mL⁻¹) | | |
| TCA | M. incognita | 67.3 | 56.5-77.2 | 6.48 ± 0.29 |
| | T. semipetrans | 75.8 | 67.4-82.0 | 8.29 ± 0.50 |
| | C. elegans | 308 | 294-322 | 11.4 ± 0.40 |
| | S. carpocapsae | >500^{d} | | |
| | H. bacteriophora | 356 | 317-386 | 9.82 ± 0.56 |
| | H. sonorensis | 421 | 399-440 | 20.5 ± 1.06 |
| | R. blumi | 345 | 333-357 | 16.6 ± 0.93 |
| PPA | M. incognita | 44.4 | 38.8-48.6 | 7.19 ± 0.43 |
| | T. semipetrans | 66.3 | 50.7-73.4 | 11.1 ± 0.79 |
| | C. elegans | 278 | 244-308 | 11.6 ± 0.60 |
| | S. carpocapsae | >400^{e} | not | 1.90 ± 0.94 |
| | | | applicable | |
| | H. bacteriophora | >400^{e} | not | 4.33 ± 0.59 |
| | | | applicable | |
| | H. sonorensis | >400^{e} | not | 0.46 ± 0.32 |
| | | | applicable | |
| | R. blumi | 346 | 327-363 | 16.1 ± 0.93 |
| | | EC₅₀^{b} (μg mL⁻¹) | | |
| ID | M. incognita | 56.3 | 52.9-59.6 | 9.48 ± 0.47 |
| | T. semipenetrans | 37.1 | 28.7-43.4 | 9.48 ± 0.47 |
| | C. elegans | 159 | 152-168 | 6.10 ± 0.22 |
| | S. carpocapsae | >400^{f} | — | — |
| | H. bacteriophora | >400^{f} | — | — |
| | H. sonorensis | >400^{f} | — | — |
| | R. blumi | 37.0 | 23.9-48.3 | 2.39 ± 0.10 |

^{a}LC₅₀: lethal concentration causing 50% nematode death.
^{b}EC₅₀: effective concertation causing 50% reversible nematode paralysis (temporary quiescence).
^{c} 95% confidence interval for the LC₅₀ or EC₅₀.
^{d}>500 indicates that nematodes were not killed at the highest concentration tested.
^{e}>400 indicates that nematodes were not killed at the highest concentration tested.
^{f} >400 indicates that nematodes were not immobilized at the highest concentration tested.

TABLE 2
Time course of TCA exposure against J2 juveniles of Meloidogyne
incognita (RKN) Tylenchulus semipenetrans (CN) under in vitro
conditions.

| | TCA | | |
|---|---|---|---|
| Nematode | Exposure | μg mL⁻¹ (95% | |
| Spp. | time | confidence interval) | Slope (± SE) |
| | | LC₅₀^{x} | |
| RKN | 24 h | 67.3 (56.5-77.2) | 6.48 ± 0.29 |
| | 48 h | 57.3 (44.0-68.2) | 6.89 ± 0.30 |
| | 72 h | 52.5 (46.3-58.0) | 10.4 ± 0.45 |
| CN | 24 h | 75.8 (67.4-82.0) | 8.29 ± 0.50 |
| | 48 h | 71.0 (63.0-76.8) | 9.17 ± 0.58 |
| | 72 h | 66.5 (58.1-72.5) | 8.10 ± 0.51 |

^{x}Concentration required for 50% mortality of tested nematode population

TABLE 3
Time course of PPA exposure against J2 juveniles of Meloidogyne
incognita (RKN) Tylenchulus semipenetrans (CN) under in vitro
conditions.

| | PPA | | |
|---|---|---|---|
| Nematode | Exposure | μg mL⁻¹ (95% | |
| Spp. | time | confidence interval) | Slope (± SE) |
| | | LC₅₀^{x} | |
| RKN241 | 24 h | 44.4 (38.8-48.6) | 7.19 ± 0.43 |
| | 48 h | 42.0 (35.4-46.9) | 7.01 ± 0.39 |
| | 72 h | 38.9 (31.2-44.9) | 6.56 ± 0.33 |
| CN | 24 h | 66.3 (50.7-73.4) | 11.1 ± 0.79 |
| | 48 h | 59.8 (51.7-65.6) | 8.78 ± 0.52 |
| | 72 h | 42.2 (20.9-65.2) | 3.76 ± 0.12 |

^{x}Concentration required for 50% mortality of tested nematode population

TABLE 4
Time course of ID exposure against J2 juveniles of Meloidogyne
incognita (RKN) Tylenchulus semipenetrans (CN) under in vitro
conditions.

| Nematode | ID Exposure | μg mL⁻¹ (95% | |
|---|---|---|---|
| Spp. | time | confidence interval) | Slope (± SE) |
| | | EC50^{y} | |
| RKN | 24 h | 56.3 (52.9-59.6) | 9.48 ± 0.47 |
| | 48 h | 61.3 (55.8-66.1) | 9.10 ± 0.43 |
| | 72 h | 76.3 (57.7-83.2) | 15.3 ± 1.27 |
| TS | 24 h | 37.1 (28.7-43.4) | 9.48 ± 0.47 |
| | 48 h | 66.2 (33.5-80.6) | 6.04 ± 0.44 |
| | 72 h | 68.3 (43.5-81.0) | 5.65 ± 0.38 |

^{y}Effective concentration required 50% reversible paralysis (temporary quiescence) of tested nematode population.

TABLE 5
The nematicidal effects and the interaction effects of individual compounds or compound mixtures caused by Photorhabdus-derived
secondary metabolites on J2 juveniles of Meloidogyne incognita under in vitro conditions.

| Compound | | | | | | | |
|---|---|---|---|---|---|---|---|
| (μg mL⁻¹) | LC₅₀^{a} | 95% Cl^{b} | Slope (± SE) | df | Additive index^{c} | | |
| Individual compounds | | | | | | | |
| TCA | 67.3 | 56.5-77.2 | 6.48 (± 0.29) | 4 | — | | |
| PPA | 44.4 | 38.8-48.6 | 7.19 (± 0.43) | 5 | — | | |
| ID | 307 | 277-338 | 23.0 (± 0.69) | 7 | — | | |
| Compound combination | | | | | | | |
| TCA + ID | 72.1 | 63.0-79.7 | 5.31 (± 0.12) | 7 | −0.31 | (−0.34 to −0.27) | Antagonistic toxicity |
| TCA + PPA | 22.9 | 16.7-28.7 | 3.18 (± 0.12) | 6 | 0.17 | (0.04 to 0.38) | Synergistic toxicity |
| PPA + ID | 40.0 | 22.8-45.6 | 8.97 (± 0.87) | 5 | −0.03 | (−0.07 to 0.49) | Additive toxicity |
| TCA + PPA + ID | 19.9 | 14.2-26.5 | 6.45 (± 0.31) | 4 | 0.24 | (0.03 to 0.49) | Synergistic toxicity |

^{a}LC₅₀: lethal concentration causing 50% nematode death.
^{b}95% confidence intervals for LC₅₀.
^{c}an additive index < 0 indicates antagonistic toxicity. An index > 0 indicates synergetic toxicity. An index with confidence intervals overlapping 0 indicates the mixture has additive toxicity.

TABLE 6
The nematicidal effects and the interaction effects of individual compounds or compound mixtures caused by Photorhabdus-derived
secondary metabolites on J2 juveniles of Tylenchulus semipenetrans under in vitro conditions

| Compound | | | | | | | |
|---|---|---|---|---|---|---|---|
| (μg mL⁻¹) | LC₅₀^{a} | 95% Cl^{b} | Slope (± SE) | df | Additive index^{c} | | |
| Individual compounds | | | | | | | |
| TCA | 75.8 | 67.4-82.0 | 8.29 (± 0.50) | 4 | | — | |
| PPA | 66.3 | 50.8-73.4 | 11.1 (± 0.79) | 5 | | — | |
| ID | 388 | 378-399 | 20.0 (± 1.96) | 5 | | — | |
| Compound combination | | | | | | | |
| TCA + ID | 91.7 | 60.3-103 | 9.17 (± 0.70) | 7 | −0.45 | (−0.51 to −0.05) | Antagonistic toxicity |
| TCA + PPA | 40.6 | 38.3-42.6 | 14.3 (± 1.09) | 6 | −0.15 | (−0.32 to −0.10) | Antagonistic toxicity |
| PPA + ID | 66.9 | 60.3-71.7 | 8.94 (± 0.50) | 6 | −0.18 | (−0.35 to −0.16) | Antagonistic toxicity |
| TCA + PPA + ID | 27.3 | 12.4-34.9 | 5.66 (± 0.43) | 5 | 0.19 | (0.01 to 1.17) | Synergistic toxicity |

^{a}LC₅₀: lethal concentration causing 50% nematode death.
^{b}95% confidence intervals for LC₅₀.
^{c}an additive index < 0 indicates antagonistic toxicity. An index > 0 indicates synergetic toxicity. An index with confidence intervals overlapping 0 indicates the mixture has additive toxicity.

### Example II

This Example describes human cytotoxicity of individual SMs. Cytotoxicity assays were performed on TCA, PPA and ID, using doxorubicin as the control. Three cancer cell lines (NCI-H460 human non-small cell lung cancer, SF-268 human central nervous system glioma, and MCF-7 human breast cancer) were used that are routinely use as “sentinels” (if a compound is cytotoxic, then at least one of these are usually killed). HFF cells (human foreskin normal cells, not cancer cells) was also used as a “control”.

Tested concentrations of these SMs increased at 50, 100 uM, then at 200 uM (Table 7). Doxorubicin at 1 uM was toxic to all (well above LC₅₀). None of the SMs were toxic even at 200 uM. The highest toxicity was for ID against NCI-H460, 30.5% at 200 uM.

Therefore, no significant human cytotoxicity was observed for any of these three SMs, at or higher the LC⁵⁰ against Meloidogyne.

TABLE 7
Human cytotoxicity (MTT) Assays of SMs after 72 hours

| | | Cancer cell | | | |
|---|---|---|---|---|---|
| | | | | | Skin; foreskin; |
| | | | | | Homo sapiens |
| | | Human non-small | Central Nervous | | (human normal |
| | | cell Lung cancer | System glioma | Breast cancer | Cell Line) |
| Treatments | Conc. | % Inh. NCI-H460 | % Inh. SF-268 | % Inh. MCF-7 | % Inh. HFF |
| TCA | 200 M | 6.89 | 13.0 | 2.59 | 10.8 |
| PPA | 200 M | 3.97 | 7.76 | −5.35 | 22.6 |
| ID | 200 M | 30.5 | 20.2 | 5.31 | 4.64 |
| Doxorubicin | 1 μM | 97.2 | 86.7 | 64.1 | 64.9 |
| (+ Control) | | | | | |

Having now fully described the invention, it will be understood by those of skill in the art that the same can be performed within a wide and equivalent range of conditions, formulations, and other parameters without affecting the scope of the invention or any embodiment thereof. All patents, patent applications and publications cited herein are fully incorporated by reference herein in their entirety.

### INCORPORATION BY REFERENCE

The entire disclosure of each of the patent documents and scientific articles referred to herein is incorporated by reference for all purposes. The following references are referenced within this application and are herein incorporated by reference in all entireties.

### EQUIVALENTS

The invention may be embodied in other specific forms without departing from the spirit or essential characteristics thereof. The foregoing embodiments are therefore to be considered in all respects illustrative rather than limiting the invention described herein. Scope of the invention is thus indicated by the appended claims rather than by the foregoing description, and all changes that come within the meaning and range of equivalency of the claims are intended to be embraced therein.

1. A method of treating or preventing infection by a nematode, comprising:
contacting said nematode with one or more metabolites selected from the group consisting of trans-cinnamic acid (TCA), (4E)-5-phenylpent-4-enoic acid (PPA), and indole (ID).

2. The method of claim 1, wherein said nematode is a plant pathogen.

3. The method of claim 1, wherein said nematode is Meloidogyne spp. and/or Tylenchulus spp.

4. The method of claim 1, wherein said metabolites have nematistatic and/or nematicidal activity.

5. The method of claim 1, wherein said metabolites are TCA+PPA or TCA+PPA+ID.

6. The method of claim 1, wherein said metabolite is applied at a concentration of 5 to 1000 μg/ml.

7. The method of claim 1, wherein said metabolite is applied at a concentration of 10 to 500 μg/ml.

8. The method of claim 1, wherein said metabolite is applied at a concentration of 10 to 400 μg/ml.

9. The method of claim 1, wherein TCA is applied at a concentration of 10 to 500 μg/ml, PPA is applied at a concentration of 10 to 400 μg/ml, and ID is applied at a concentration of 10 to 400 μg/ml.

10. The method of claim 1, wherein said metabolite does not kill or inhibit the growth of beneficial soil nematodes.

11. The method of claim 1, wherein said metabolite is applied to a plant and/or soil.

12. The method of claim 1, wherein said contacting is repeated one or more times.

13. The method of claim 12, wherein said contacting is repeated at regular or irregular intervals.

14. The method of claim 1, wherein said metabolites are secondary metabolites of Photorhabdus bacteria.

15. The method of claim 14, wherein said Photorhabdus bacteria is Photorhabdus l. sonorensis.

16. The method of any of the preceding claims claim 1, wherein said metabolites are chemically synthesized.

17-22. (canceled)
